(19) United States
(12) Patent Application Publication
(10) Pub. No.: US 2026/0072290 A1
(43) Pub. Date: Mar. 12, 2026

(54) WAVELENGTH SEPARATION ELEMENT AND OPTICAL ELEMENT

(71) Applicant: FUJIFILM Corporation, Tokyo (JP)

(72) Inventors: Yujiro YANAI, Minamiashigara-shi (JP); Kazuya HISANAGA, Minamiashigara-shi (JP)

(73) Assignee: FUJIFILM Corporation, Tokyo (JP)

(21) Appl. No.: 19/394,262

(22) Filed: Nov. 19, 2025

Related U.S. Application Data
(63) Continuation of application No. PCT/JP2024/021277, filed on Jun. 12, 2024.

(30) Foreign Application Priority Data
Jun. 12, 2023 (JP) 2023-096202

(51) Int. Cl. G02B 27/10

(52) U.S. Cl. CPC G02B 27/1086

(57) ABSTRACT

An object is to provide a wavelength separation element of suppressing a spread of diffracted light even in a case where a diffraction element having a large diffraction angle is used, and an optical element using the wavelength separation element. The object is achieved by a wavelength separation element including a diffraction element, an optically anisotropic layer, and an adhesive layer or an alignment film layer therebetween, in which an absolute value of an angle α between a normal line of a diffraction element plane and a specular reflection direction or a specular transmission direction of incident light and an absolute value of a diffraction angle β of the diffraction element satisfy an expression of “∥α|±|β∥≥20°”, and a film thickness distribution of the entire wavelength separation element is within ±3.0% of an average film thickness and a surface roughness (Ra) is 30 nm or less. In the expression, in a case where a direction of the diffracted light is different from a direction from the normal line of the diffraction element plane toward the specular reflection direction or the specular transmission direction, the sign is positive (+), and in a case where the direction of the diffracted light is the same as the direction from the normal line of the diffraction element plane toward the specular reflection direction or the specular transmission direction, the sign is negative (−).

### CROSS-REFERENCE TO RELATED APPLICATIONS

This application is a Continuation of PCT International Application No. PCT/JP2024/021277 filed on Jun. 12, 2024, which claims priority under 35 U.S.C. § 119 (a) to Japanese Patent Application No. 2023-096202 filed on Jun. 12, 2023. The above applications are hereby expressly incorporated by reference, in their entirety, into the present application.

### BACKGROUND OF THE INVENTION

### 1. Field of the Invention

The present invention relates to a field of optical communication technology, and particularly to a wavelength separation element and an optical element using the wavelength separation element.

### 2. Description of the Related Art

In an optical transmission network, in order to cope with an increase in network capacity, it is required to improve performance of a wavelength selective switch (WSS) used in wavelength-division multiplexing communication and to increase the number of available apparatuses by reducing a size of the apparatus.

In the apparatus, in order to separate wavelengths of incident light and to distribute the light in an appropriate direction, an optical direction-control device represented by a combination of a wavelength separation element and liquid crystal on silicon (LCOS) has been used.

In such an optical direction-control device, it is required to minimize a loss of light having each wavelength and to guide the light to an output-side optical fiber.

### SUMMARY OF THE INVENTION

In recent years, in association with an increase in performance and a reduction in size of the apparatus, a wavelength separation element having a large diffraction angle is used. In such a wavelength separation element, in a case where diffracted light has a spread due to a diffraction element itself or an optical member on which the diffraction element is bonded, there is light which does not enter the optical fiber, and thus energy loss occurs.

As a result of intensive studies by the present inventors, it has been found that the spread of the diffracted light is caused by smoothness of the diffraction element itself and an optical member on which the diffraction element is bonded.

An object of the present invention is to provide a wavelength separation element capable of suppressing a spread of diffracted light even in a case where a diffraction element having a large diffraction angle is used, and an optical element using the wavelength separation element.

The present inventors have found that the above-described objects can be achieved by the following configurations.

[1] A wavelength separation element comprising at least:
a diffraction element;
an optically anisotropic layer; and
an adhesive layer or an alignment film layer between the diffraction element and the optically anisotropic layer,
in which the diffraction element is a diffraction element in which an absolute value (|α|) of an angle α between a normal line of a diffraction element plane and a specular reflection direction or a specular transmission direction of incident light and an absolute value (|β|) of a diffraction angle β of the diffraction element satisfy an expression (1), and
a film thickness distribution of an entire wavelength separation element is within ±3.0% of an average film thickness and a surface roughness (Ra) is 30 nm or less,

$$‖ α \vert \pm \vert β ‖ \geq 20 ° , \qquad the expression ( 1 )$$

here, in a case where a direction of the diffracted light is different from a direction from the normal line of the diffraction element plane toward the specular reflection direction or the specular transmission direction, the sign is positive (+), and in a case where the direction of the diffracted light is the same as the direction from the normal line of the diffraction element plane toward the specular reflection direction or the specular transmission direction, the sign is negative (−).

[2] The wavelength separation element according to [1],
in which the diffraction element is a liquid crystal diffraction element.

[3] The wavelength separation element according to [1] or [2],
in which the diffraction element is a laminate of a plurality of liquid crystal diffraction elements.

[4] The wavelength separation element according to any one of [1] to [3],
in which the optically anisotropic layer consists of a liquid crystal compound.

[5] The wavelength separation element according to any one of [1] to [4],
in which the optically anisotropic layer consists of a liquid crystal compound and is a λ/4 plate.

[6] An optical element comprising:
the wavelength separation element according to any one of [1] to [5]; and
an optical refractive element.

According to the present invention, it is possible to provide a wavelength separation element having a large diffraction angle, which suppresses a spread of diffracted light, and an optical element using the wavelength separation element.

### BRIEF DESCRIPTION OF THE DRAWINGS

FIG. 1 is a view conceptually showing a configuration of the present invention.

FIG. 2 is a view for describing a diffraction element.

FIG. 3 is a view for describing the diffraction element.

FIG. 4 is a view for describing a diffraction element.

FIG. 5 is a view for describing the diffraction element.

FIG. 6 is a view for describing a method of measuring diffracted light in Examples.

FIG. 7 is a conceptual view for describing a liquid crystal diffraction element.

### DESCRIPTION OF THE PREFERRED EMBODIMENTS

Hereinafter, the wavelength separation element and the optical element according to the present invention will be described in detail based on suitable embodiments shown in the accompanying drawings.

Any numerical range expressed using “to” in the present specification refers to a range including the numerical values before and after the “to” as a lower limit value and an upper limit value, respectively.

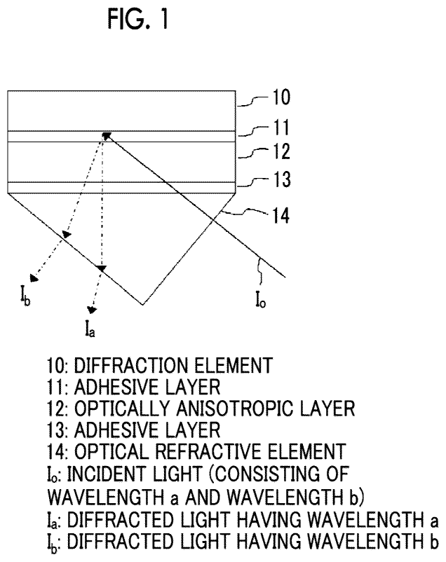

FIG. 1 conceptually shows an example of the optical element according to the embodiment of the present invention, using an example of the wavelength separation element according to the embodiment of the present invention.

An optical element shown in FIG. 1 includes a diffraction element 10, an adhesive layer 11, an optically anisotropic layer 12, an adhesive layer 13, and an optical refractive element 14. In the optical element, the diffraction element 10, the adhesive layer 11, and the optically anisotropic layer 12 constitute the wavelength separation element according to the embodiment of the present invention.

In the wavelength separation element according to the embodiment of the present invention, the adhesive layer 11 provided between the diffraction element 10 and the optically anisotropic layer 12 may be an alignment film layer. Similarly, in the optical element according to the embodiment of the present invention, the adhesive layer 13 provided between the optically anisotropic layer 12 and the optical refractive element 14 may be an alignment film layer.

Here, with regard to the wavelength separation element according to the embodiment of the present invention, in the diffraction element, an absolute value (|α|) of an angle α between a normal line of a diffraction element plane (surface) and a specular reflection direction or a specular transmission direction of incident light and an absolute value (|β|) of a diffraction angle β of the diffraction element satisfy “∥α|±|β∥≥20°”. In the expression, in a case where a direction of the diffracted light is different from a direction from the normal line of the diffraction element plane toward the specular reflection direction or the specular transmission direction, the sign is positive (+), and in a case where the direction of the diffracted light is the same as the direction from the normal line of the diffraction element plane toward the specular reflection direction or the specular transmission direction, the sign is negative (−).

Furthermore, with regard to the wavelength separation element according to the embodiment of the present invention, a film thickness distribution of the entire wavelength separation element is within ±3.0% of an average film thickness, and a surface roughness Ra is 30 nm or less.

The wavelength separation element according to the embodiment of the present invention has such a configuration, and thus realizes a wavelength separation element having a large diffraction angle and suppressing a spread of diffracted light.

This will be described in detail later.

In the wavelength separation element shown in FIG. 1, the diffraction element 10 diffracts incident light I₀ in which light having a wavelength a and light having a wavelength b are mixed, and separates the incident light I₀ into diffracted light Iₐ (wavelength a) and diffracted light I_{b} (wavelength b).

In addition, the optically anisotropic layer 12 is provided to change a polarization state of the incident light I₀ into an appropriate state for diffraction of light in the diffraction element 10.

In the wavelength separation element, the diffraction element 10 and the optically anisotropic layer 12 are bonded to each other by the adhesive layer 11.

In addition, in the optical element shown in FIG. 1, the optical refractive element 14 is provided to control an incidence angle of the incident light I₀ on the diffraction element 10 and to control directions of the diffracted light Iₐ and the diffracted light I_{b} diffracted by the diffraction element 10.

In the optical element, the optical refractive element 14 is bonded to the optically anisotropic layer 12 by the adhesive layer 13.

In the optical element shown in FIG. 1, the incident light I₀ in which the light having the wavelength a and the light having the wavelength b are mixed is incident from a normal direction on one surface of the optical refractive element 14 (for example, a prism). The incident light I₀ incident on the optical refractive element 14 is transmitted through the optical refractive element 14 and the adhesive layer 13, and is incident on the optically anisotropic layer 12.

The incident light I₀ incident on the optically anisotropic layer 12 is transmitted through the optically anisotropic layer 12 by changing the polarization state, for example, by being converted into circularly polarized light, is transmitted through the adhesive layer 11, and is incident on the diffraction element 10.

In the optical element (wavelength separation element) shown in FIG. 1, for example, the diffraction element 10 is a reflective type diffraction element. The incident light I₀ incident on the diffraction element 10 is reflected and diffracted by the diffraction element 10, and is separated into the diffracted light Iₐ and the diffracted light I_{b} having different diffraction angles depending on the wavelength a and the wavelength b of the light.

The diffracted light Iₐ and the diffracted light I_{b} separated depending on the wavelengths are transmitted through the adhesive layer 11 and are incident on the optically anisotropic layer 12. The diffracted light Iₐ and the diffracted light I_{b} incident on the optically anisotropic layer 12 are transmitted through the optically anisotropic layer 12 by changing the polarization state, for example, by being converted into linearly polarized light, are transmitted through the adhesive layer 13, and are incident on the optical refractive element 14.

The diffracted light Iₐ and the diffracted light I_{b}, incident on the optical refractive element 14, are transmitted through the optical refractive element 14 by being refracted by the optical refractive element 14, and are emitted from the optical element as light having the wavelength a (diffracted light Iₐ) and light having the wavelength b (diffracted light I_{b}), which have different traveling directions.

The light having the wavelength a and the light having the wavelength b, emitted from the optical element, are incident on, for example, an optical fiber constituting an optical transmission network. Here, the light having the wavelength a and the light having the wavelength b are wavelength-separated by the wavelength separation element according to the embodiment of the present invention, and thus spread of the light is suppressed. Accordingly, the light having the wavelength a and the light having the wavelength b are incident on the optical fiber without loss, and are transmitted through the optical transmission network.

### (Diffraction Element)

In the wavelength separation element according to the embodiment of the present invention, the diffraction element 10 is not limited thereto, and various known diffraction elements represented by a liquid crystal diffraction element, a surface relief type element having a fine uneven pattern, a volume hologram having a refractive index distribution in an element interior, and the like are available.

Among these, a liquid crystal diffraction element is suitably exemplified. In particular, as the liquid crystal diffraction element, a liquid crystal diffraction element formed of a composition containing a liquid crystal compound, the liquid crystal diffraction element having a predetermined liquid crystal alignment pattern in which an orientation of an optical axis derived from the liquid crystal compound is continuously rotated in one in-plane direction, is suitably used.

In addition, in the liquid crystal diffraction element, from the viewpoint of high efficiency of the diffracted light, polarization maintenance properties, and the like, it is preferable that the liquid crystal diffraction element has a so-called twist structure (twisted structure) in which the orientation of the liquid crystal compound continuously changes from one interface side to the other interface side in a thickness direction, and has a cholesteric structure having a short period of the twist structure.

In the wavelength separation element according to the embodiment of the present invention, the diffraction element may be a reflective type diffraction element or a transmissive type diffraction element.

FIG. 7 conceptually shows the above-described liquid crystal alignment pattern in the liquid crystal diffraction element. FIG. 7 shows a surface of a liquid crystal layer constituting the liquid crystal diffraction element on an alignment film side.

As described above, the liquid crystal alignment pattern is a liquid crystal alignment pattern in which an orientation of an optical axis 40A derived from a liquid crystal compound 40 continuously rotates in one direction in a plane of the liquid crystal layer while changing.

The optical axis 40A derived from the liquid crystal compound 40 is a slow axis in the liquid crystal compound 40. In FIG. 7, since a rod-like liquid crystal compound is exemplified as the liquid crystal compound 40, the optical axis 40A is along a major axis direction of the liquid crystal compound.

As shown in FIG. 7, in the liquid crystal layer having the liquid crystal alignment pattern, the liquid crystal compound 40 is two-dimensionally arranged in X and Y directions orthogonal to each other in the plane.

In the liquid crystal layer of the example shown in the drawing, the orientation of the optical axis 40A continuously rotates while changing in the X direction. That is, an angle between the optical axis 40A of the liquid crystal compound 40 arranged in the X direction and the X direction sequentially changes from θ to θ+180° or θ−180° along the X direction.

On the other hand, in the Y direction orthogonal to the X direction, the orientation of the optical axis 40A is the same.

In the X direction, a length in which the orientation of the optical axis 40A rotates by 180°, that is, a distance A during which the angle between the optical axis 40A and the X direction changes from θ to θ+180° or θ−180° along the X direction is a single period in a diffraction structure of the liquid crystal diffraction element. In other words, in a case where the orientation of the optical axis 40A at a certain position in the X direction is 0°, the distance ∧ during which the orientation of the optical axis 40A continuously changes from 0° to 180° is a single period in the diffraction structure of the liquid crystal diffraction element.

In the present invention, the single period in the diffraction structure of the liquid crystal diffraction element is basically constant.

The distance ∧ of the single period corresponds to an in-plane pitch a described below in the liquid crystal diffraction element.

### (Reflective Type Diffraction Element)

In the wavelength separation element according to the embodiment of the present invention, the reflective type diffraction element is not limited, and various known reflective type diffraction elements are available.

In a case of the reflective type diffraction element, the in-plane pitch a [nm], that is, the distance of the single period in the diffraction structure of the diffraction element is determined from the following expression of the first-order diffracted light. In the reflective type diffraction element, as the in-plane pitch a, that is, the distance of the single period in the diffraction structure is shorter, the diffraction angle of the light by the diffraction element is larger. In a case of the reflective type liquid crystal diffraction element, a photo-alignment film may be appropriately subjected to interference exposure based on the reflective type liquid crystal diffraction element.

$$n \times a \times ( sin β + sin α ) = λ$$

Here, in a case of the liquid crystal diffraction element, as described above, the in-plane pitch a is the distance during which the liquid crystal compound continuously changes from 0° to 180° in the plane.

In addition, n is an environmental refractive index on an incidence side of the diffraction element, λ is a wavelength [nm] of the incident light, α is an angle between the incident light incident on the diffraction element and a normal line of the diffraction element surface, and β is an angle between the reflected diffracted light in the diffraction element and the normal line of the diffraction element surface.

The reflective type liquid crystal diffraction element is a cholesteric liquid crystal layer having the above-described liquid crystal alignment pattern. That is, in a case of the reflective liquid crystal diffraction element, it is necessary to have cholesteric alignment in which the liquid crystal compound is twisted and aligned in a helical shape in the thickness direction. In other words, the reflective type liquid crystal diffraction element needs to have a structure in which a cholesteric liquid crystalline phase is fixed.

In addition, in the cholesteric liquid crystal layer, a film thickness d [nm] of the liquid crystal layer may be appropriately adjusted according to required efficiency.

For example, in order to increase utilization efficiency of the light, the thickness of the liquid crystal layer may be adjusted to be 7 times or more a helical pitch of the cholesteric alignment. That is, the cholesteric liquid crystal layer has the helical pitch a plurality of times, and it is preferable to repeat the helical pitch seven or more times.

As is well known, the cholesteric liquid crystal layer selectively reflects light in a specific wavelength range according to a length of the helical pitch of the cholesteric alignment. Specifically, the cholesteric liquid crystal layer selectively reflects long-wavelength light as the helical pitch is longer. Accordingly, the helical pitch of the cholesteric liquid crystal layer may be appropriately determined depending on a wavelength (wavelength of incident light) to be used.

Specifically, the helical pitch of the cholesteric alignment is a thickness in the thickness direction of the cholesteric liquid crystal layer, in which an orientation of the liquid crystal compound changes from 0° to 360° in the thickness direction in the helical twisted alignment of the liquid crystal compound.

As such a reflective type liquid crystal diffraction element, various known reflective type liquid crystal diffraction elements such as liquid crystal diffraction elements described in JP2023-160888A and WO2021-256422A are available.

### (Transmissive Type Diffraction Element)

On the other hand, the diffraction element may be a transmissive type diffraction element. The transmissive type diffraction element is not limited, and various known transmissive type diffraction elements are available.

In a case of the transmissive type diffraction element, the in-plane pitch a [nm], that is, the single period in the diffraction structure of the diffraction element is determined from the following expression of the first-order diffracted light. Even in the transmissive type diffraction element, as the in-plane pitch a, that is, the distance of the single period in the diffraction structure is shorter, the diffraction angle of the light by the diffraction element is larger. In a case of the liquid crystal diffraction element, a photo-alignment film may be appropriately subjected to interference exposure based on the reflective type liquid crystal diffraction element.

$$n \times a \times ( sin β - sin α ) = λ$$

As described above, in a case of the liquid crystal diffraction element, the in-plane pitch a is the distance during which the liquid crystal compound continuously changes from 0° to 180° in the plane.

In addition, n is an environmental refractive index on an incidence side of the diffraction element, λ is a wavelength [nm] of the incident light, α is an angle between the incident light incident on the diffraction element and a normal line of the diffraction element surface, and β is an angle between the transmitted diffracted light and the normal line of the diffraction element surface.

The transmissive type liquid crystal diffraction element includes a liquid crystal layer having the above-described liquid crystal alignment pattern.

In addition, in a case of the transmissive type liquid crystal diffraction element, the liquid crystal compound for forming the liquid crystal layer and the film thickness of the liquid crystal layer may be appropriately selected such that Δnλ×d, which is a product of a refractive index anisotropy Δnλ of the optically anisotropic layer described later at a wavelength λ [nm] and a film thickness d [nm] of the liquid crystal layer, is λ/2.

As such a transmissive type liquid crystal diffraction element, various known transmissive type liquid crystal diffraction elements such as liquid crystal diffraction elements described in WO2021/256413A and JP2023-160888A are available.

### (Diffraction Element Having Large Diffraction Angle)

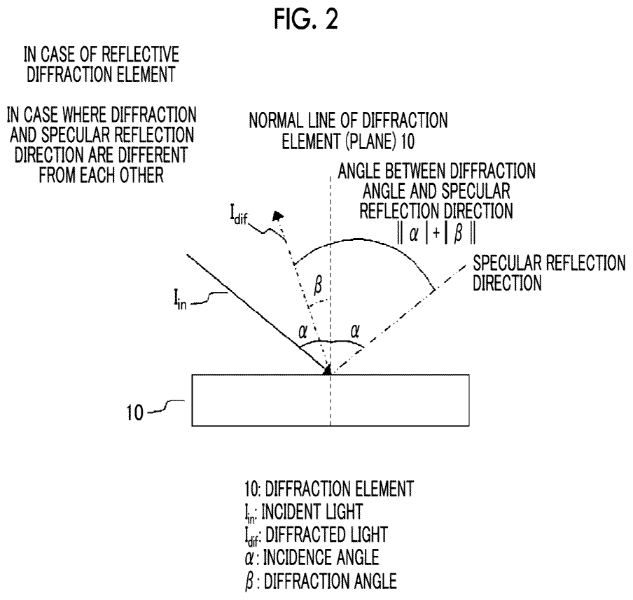

In the present invention, the diffraction element having a large diffraction angle means that an angle between a specular reflection direction or a specular transmission direction of incident light and diffracted light by the diffraction element is large, as conceptually shown in FIGS. 2 to 5. Specifically, an absolute value of an angle α between a normal line of a diffraction element plane and a specular reflection direction or a specular transmission direction of incident light and an absolute value of a diffraction angle β of the diffraction element satisfy the following expression (1).

$$‖ α \vert \pm \vert β ‖ \geq 20 ° \qquad Expression ( 1 )$$

Here, the specular reflection direction is a direction in which light is reflected at the same angle as the angle between the incident light and the normal line of the diffraction element plane and in a direction different from the incident light. In addition, the specular transmission direction is a direction in which light transmits through a substance in a direction parallel to the incident light.

Furthermore, in ∥α|±|β∥, in a case where a direction of the diffracted light is different from a direction from the normal line of the diffraction element plane toward the specular reflection direction or the specular transmission direction, the sign is positive (+), and in a case where the direction of the diffracted light is the same as the direction from the normal line of the diffraction element plane toward the specular reflection direction or the specular transmission direction, the sign is negative (−).

That is, the expression (1) represents that the diffraction angle is larger as the direction of the diffracted light deviates from the specular reflection direction or the specular transmission direction. In a case where such a diffraction element having a large diffraction angle is used, the film thickness distribution and the surface roughness Ra significantly affect the spread and the separation of the diffracted light.

FIG. 2 shows a case in which a direction of diffracted light I_{dif} (one-dot chain line) in the reflective type diffraction element 10 is different from a specular reflection direction (two-dot chain line) of incident light Iᵢₙ (solid line) with respect to a normal line of a diffraction element plane (surface).

In this case, as shown in FIG. 2, a sum of the absolute value |α| of the angle α between the normal line (broken line) of the diffraction element plane (surface) and the specular reflection direction of the incident light Iᵢₙ and the absolute value |β| of the diffraction angle β of the diffracted light I_{dif}, that is, ∥α|+|β∥ is 20° or more.

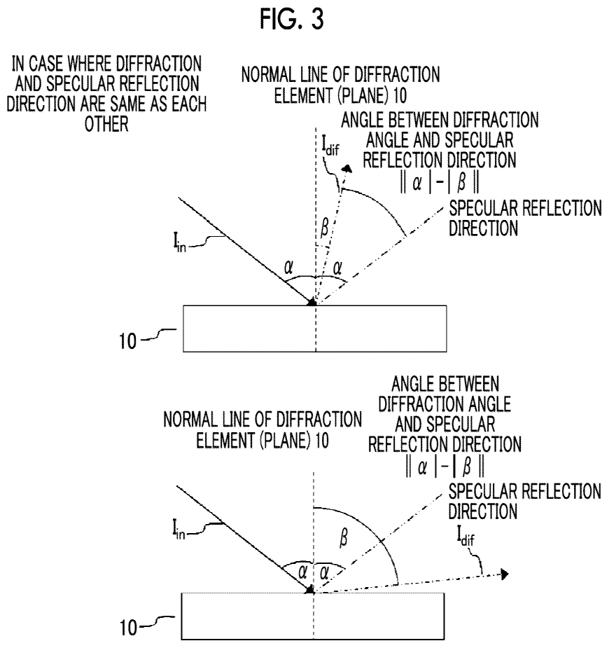

FIG. 3 shows a case in which a direction of diffracted light I_{dif} (one-dot chain line) in the reflective type diffraction element 10 is the same as a specular reflection direction (two-dot chain line) of incident light Iᵢₙ (solid line) with respect to a normal line of a diffraction element plane (surface).

In this case, as shown in FIG. 3, a difference between the absolute value |α| of the angle α between the normal line (broken line) of the diffraction element plane (surface) and the specular reflection direction of the incident light Iᵢₙ and the absolute value |β| of the diffraction angle β of the diffracted light I_{dif}, that is, ∥α|−|β∥ is 20° or more.

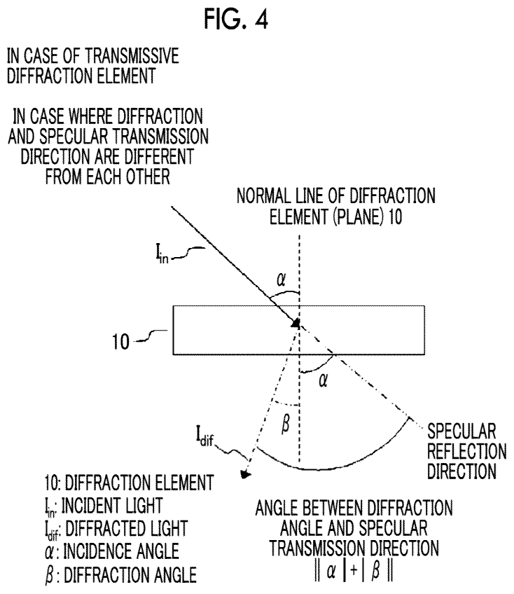

FIG. 4 shows a case in which a direction of diffracted light I_{dif} (one-dot chain line) in the transmissive type diffraction element 10 is different from a specular transmission direction (two-dot chain line) of incident light Iᵢₙ (solid line) with respect to a normal line of a diffraction element plane (surface).

In this case, as shown in FIG. 4, a sum of the absolute value |α| of the angle α between the normal line (broken line) of the diffraction element plane (surface) and the specular transmission direction of the incident light Iᵢₙ and the absolute value |β| of the diffraction angle β of the diffracted light I_{dif}, that is, ∥α|+|β∥ is 20° or more.

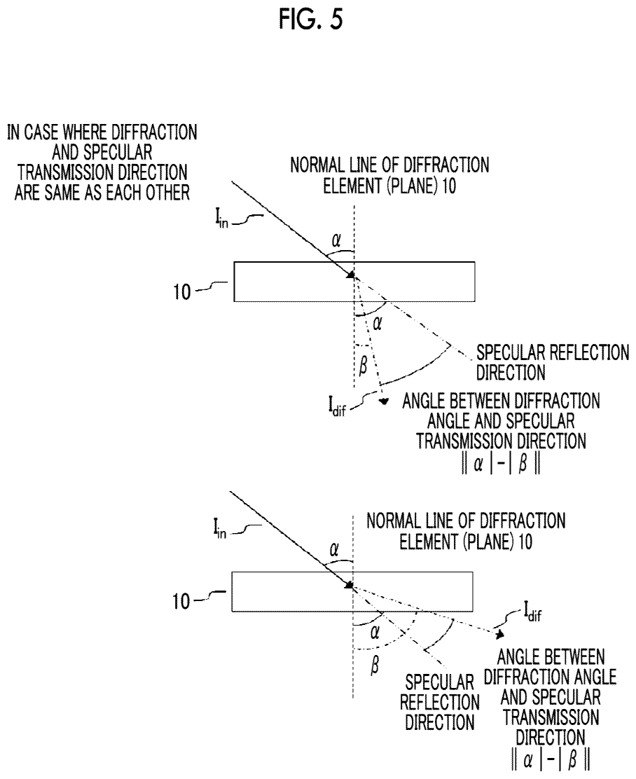

FIG. 5 conceptually shows a case in which a direction of diffracted light I_{dif} (one-dot chain line) in the transmissive type diffraction element 10 is the same as a specular transmission direction (two-dot chain line) of incident light Iᵢₙ (solid line) with respect to a normal line of a diffraction element plane (surface).

In this case, as shown in FIG. 5, a difference between the absolute value |α| of the angle α between the normal line (broken line) of the diffraction element plane (surface) and the specular transmission direction of the incident light Iᵢₙ and the absolute value |β| of the diffraction angle β of the diffracted light I_{dif}, that is, ∥α|−|β∥ is 20° or more.

(Formation of in-Plane Alignment Pattern)

In addition, forming an in-plane alignment pattern required for the diffraction is not particularly limited, and a known method can be used. As an example, interference exposure with circularly polarized light, such as an exposure device described in FIG. 3 of WO2021/256413A, may be used.

Specifically, in a case of the liquid crystal diffraction element, a film which is to be a photo-alignment film containing a photo-alignment material is formed on a surface of a support selected as appropriate. The film which is to be the photo-alignment film is subjected to interference exposure with circularly polarized light having an opposite rotation direction using the exposure device described in FIG. 3 of WO2021/256413A to form an alignment pattern corresponding to a liquid crystal alignment pattern in the photo-alignment film.

Thereafter, for example, a composition containing a liquid crystal compound is applied onto and dried (heated) on the photo-alignment film on which the alignment pattern is formed, and the composition is cured by ultraviolet (UV) irradiation or the like as necessary to form a liquid crystal layer. As a result, a liquid crystal diffraction element having a liquid crystal alignment pattern in which an orientation of an optical axis derived from the liquid crystal compound continuously rotates while changing in one in-plane direction as shown in FIG. 7 can be formed.

In order to form the in-plane pitch alignment pattern required to obtain a diffraction angle for separating light corresponding to a wavelength of incident light, an optical element of the exposure device may be installed such that an absolute value of an incidence angle of each interference exposure is the same angle with respect to a normal direction of the photo-alignment film surface. For example, in a case of the exposure device described in FIG. 3 of WO2021/256413A, an angle at which two circularly polarized light beams having opposite rotation directions intersect each other is adjusted in the interference exposure of the photo-alignment film. By adjusting the angle, the length of the in-plane pitch can be adjusted in the liquid crystal diffraction element, and the in-plane pitch (distance A of the single period) in the liquid crystal alignment pattern can be adjusted.

As described above, in the diffraction element, as the in-plane pitch is smaller, the diffraction angle of the diffracted light is larger.

In addition, in the diffraction element, in general, as the wavelength of the light is longer, the diffraction angle of the diffracted light is larger.

### (Formation of Twist Structure or Cholesteric Alignment)

As described above, it is preferable that the transmissive type liquid crystal diffraction element has a twist structure in which the liquid crystal compound is twisted and aligned in a helical shape in the thickness direction. It is preferable that a twist angle (twisted angle) of the liquid crystal compound is 360° or less.

In addition, the reflective type liquid crystal diffraction element has a cholesteric liquid crystal layer in which the liquid crystal compound is cholesterically aligned and a helical pitch in which the liquid crystal compound is twisted and aligned in a helical shape by 360° in the thickness direction is repeated a plurality of times.

In order to obtain a desired twist structure or cholesteric alignment in the thickness direction, for example, an addition amount of a chiral agent added to the liquid crystal composition for forming the liquid crystal layer described in WO2021/256413A may be appropriately adjusted.

In addition, WO2021/256413A and the like can be referred to for the support and the photo-alignment film.

However, in a case where the wavelength separation element according to the embodiment of the present invention is used for optical communication, it is necessary to consider that a wavelength of light used for the optical communication is often in an infrared wavelength range.

The diffraction element may be a laminate of a plurality of liquid crystal diffraction elements.

For example, in a case where the liquid crystal diffraction element is the reflective type diffraction element using the cholesteric liquid crystal layer having the above-described liquid crystal alignment pattern, the diffraction element may be a laminate in which a plurality of layers of the liquid crystal diffraction elements having cholesteric liquid crystal layers with different wavelength ranges to be selectively reflected are laminated.

In addition, as the diffraction element of the laminate in which a plurality of liquid crystal diffraction elements are laminated, a laminate of a reflective type liquid crystal diffraction element of a right-handed cholesteric liquid crystal layer and a reflective type liquid crystal diffraction element of a left-handed cholesteric liquid crystal layer, a laminate of reflective type diffraction elements having different in-plane pitches, a laminate of elements in which both of these are combined, and the like can also be used.

### (Optically Anisotropic Layer)

In the wavelength separation element according to the embodiment of the present invention, the optically anisotropic layer 12 is bonded to the diffraction element 10 by the adhesive layer 11 (alignment film layer).

The optically anisotropic layer 12 is not particularly limited, and various optically anisotropic layers can be used. As an example, an optically anisotropic layer 12 which sets a polarization state of light transmitted through the optically anisotropic layer 12 to a desired polarization state, that is, an optically anisotropic layer 12 which sets a polarization state of light incident on the diffraction element 10 to a desired polarization state is preferably exemplified. By using such an optically anisotropic layer 12, it is possible to make it difficult for the polarization state to change due to reflection, refraction, or the like, which is preferable.

A material for forming the optically anisotropic layer 12 is not limited, and a known material such as a polymer, a liquid crystal compound, and an inorganic substance can be used. In particular, in a case where the diffraction element is the liquid crystal diffraction element, from the viewpoint of reducing a difference in refractive index, an optically anisotropic layer formed of the same liquid crystal compound as in the liquid crystal diffraction element is more preferable.

Specifically, in a case where the diffraction element is the liquid crystal diffraction element, a retardation layer, particularly a λ/4 wavelength plate is suitably used as the optically anisotropic layer 12.

In a case where the diffraction element 10 is the liquid crystal diffraction element, the incident light can be efficiently diffracted by incidence of circularly polarized light. In particular, the reflective type liquid crystal diffraction element (cholesteric liquid crystal layer) can efficiently diffract and reflect the incident light by the incidence of circularly polarized light having a predetermined rotation direction.

Accordingly, in a case where the diffraction element 10 is the liquid crystal diffraction element, the incident light can be efficiently diffracted and wavelength-separated by the diffraction element 10 using the retardation layer, particularly the λ/4 wavelength plate as the optically anisotropic layer 12, and converting the incident light incident on the diffraction element 10 into circularly polarized light.

The λ/4 wavelength plate is not limited, and a known λ/4 wavelength plate can be used. Examples thereof include a stretched polycarbonate film, a stretched norbornene-based polymer film, a transparent film in which inorganic particles having birefringence such as strontium carbonate are included and aligned, a thin film in which oblique deposition of an inorganic dielectric is performed on a support, a film in which the polymerizable liquid crystal compound is uniaxially aligned and the alignment is immobilized, and a film in which the liquid crystal compound is uniaxially aligned and the alignment is immobilized. Among these, the film in which the liquid crystal compound is uniaxially aligned and the alignment is immobilized is suitably used for the above-described reason.

### (Adhesive Layer)

The wavelength separation element according to the embodiment of the present invention is configured by bonding the diffraction element 10 and the optically anisotropic layer 12 to each other by the adhesive layer 11.

In addition, the optical refractive element 14 described later is bonded to the optically anisotropic layer 12 by the adhesive layer 13.

In the following description, the adhesive layer 11 will be described as a representative example, but the same applies to the adhesive layer 13.

The adhesive layer 11 (adhesive layer 13) is not limited, and various known adhesives can be used. Examples thereof include a UV adhesive and an adhesive layer using SiOx. In addition, a pressure sensitive adhesive can also be used for the adhesive layer 11.

As the adhesive, a commercially available adhesive or the like can be optionally used. Examples thereof include an epoxy resin-based adhesive and an acrylic resin-based adhesive.

In addition, a pressure sensitive adhesive can also be used for the adhesive layer 11.

From the viewpoint of reducing the surface roughness Ra of the wavelength separation element, the pressure sensitive adhesive and the adhesive can select appropriate viscoelasticity or thickness such that the surface unevenness of the layer to be adhered can be embedded. From the viewpoint of embedding the surface unevenness, it is preferable that the pressure sensitive adhesive and the adhesive have a viscosity of 50 cP or more. In addition, it is preferable that the thickness thereof is more than a height of the surface unevenness.

From the viewpoint of reducing unnecessary reflection and suppressing a decrease in polarization degree of transmitted light and reflected light, it is preferable that the adhesive layer 11 (adhesive and pressure sensitive adhesive) used for adhering the layers has a small difference in refractive index with the adjacent layers.

Specifically, the difference in refractive index between the adhesive layer 11 and the adjacent layers is preferably 0.05 or less, and more preferably 0.01 or less. The refractive index of the pressure sensitive adhesive and the adhesive can be adjusted, for example, by adding and mixing fine particles. Examples of the fine particles to be added include fine particles of titanium oxide and fine particles of zirconia.

In addition, the adhesion by the adhesive layer 11 using SiOx can be performed in the following procedures (1) to (3).
(1) A layer to laminate is bonded to a temporary support consisting of a glass base material.
(2) An SiOx layer having a thickness of 100 nm or less is formed on both the surface of the layer to laminate and the surface of the layer to be laminated by vapor deposition or the like; the vapor deposition can be carried out by, for example, a vapor deposition device (model number ULEYES, manufactured by ULVAC, Inc.) using SiOx powder as a vapor deposition source; here, in a case of bonding to the optical refractive element, the SiOx layer may be formed on the optical refractive element surface consisting of glass.
(3) After the formed SiOx layers are bonded to each other, the temporary support is peeled off.

The wavelength separation element according to the embodiment of the present invention can be produced by, for example, the following method.

The following example is an example in which the liquid crystal diffraction element is used as the diffraction element, but a wavelength separation element using another diffraction element can also be produced according to the following method.

First, the above-described alignment film is formed on the surface of the support selected as appropriate, and the diffraction element 10 (liquid crystal diffraction element) is formed on the alignment film. As a result, a laminate including the support, the alignment film, and the diffraction element 10 is produced. The alignment film and the liquid crystal diffraction element may be formed by a known method according to the forming material, such as the above-described method.

On the other hand, the alignment film is formed on the surface of the support selected as appropriate, and for example, the optically anisotropic layer 12 consisting of a liquid crystal compound is formed on the alignment film. As a result, a laminate including the support, the alignment film, and the optically anisotropic layer 12 is produced. The alignment film and the optically anisotropic layer 12 may be formed by a known method according to the forming material, such as the above-described method.

Next, the adhesive which forms the adhesive layer 11 is applied onto the formed diffraction element 10 and/or optically anisotropic layer 12, and the two laminates are stacked with the diffraction element 10 and the optically anisotropic layer 12 facing each other. Furthermore, the adhesive is cured by a method according to the adhesive, such as ultraviolet irradiation and heating, to bond the diffraction element 10 and the optically anisotropic layer 12 to each other by the adhesive layer 11.

After bonding the diffraction element 10 and the optically anisotropic layer 12 to each other, the alignment film and the support are peeled off from the diffraction element 10, and the alignment film and the support are peeled off from the optically anisotropic layer 12. As a result, the wavelength separation element according to the embodiment of the present invention, including the diffraction element 10, the adhesive layer 11, and the optically anisotropic layer 12, is produced.

### (Support)

As described above, the diffraction element 10 (liquid crystal diffraction element) and the optically anisotropic layer 12 are formed using a support, for example.

In this case, it is preferable that the diffraction element 10 and the optically anisotropic layer 12 are formed on a support having high rigidity. This is because smoothness of the layer to be laminated can be increased by forming the diffraction element 10 and the optically anisotropic layer 12 on the support having high rigidity.

The support having high rigidity is not particularly limited, and examples thereof include a glass plate and a film with hard coat.

An elastic modulus (Young's modulus) of the support is not limited, but is preferably 5 GPa or more, more preferably 25 GPa or more, and still more preferably 50 GPa or more.

### (Lamination Through Alignment Film)

As described above, in the wavelength separation element according to the embodiment of the present invention, the alignment film layer may be used instead of the adhesive layer 11.

The alignment film layer is not limited, and a known alignment film such as the above-described photo-alignment film can be used according to the forming material of the liquid crystal layer formed on the alignment film.

In a case where the alignment film is used instead of the adhesive layer 11, the diffraction element 10 and the optically anisotropic layer 12 are adhered to each other through the alignment film. That is, in a case of forming the layer, the next layer is formed on the already formed layer through the alignment film, so that the adhesive layer cannot be used.

For example, as described above, after producing the laminate including the support, the alignment film, and the optically anisotropic layer 12, an alignment film may be formed on the surface of the optically anisotropic layer, and the liquid crystal diffraction element may be formed on the alignment film as the diffraction element 10.

Alternatively, as described above, after producing the laminate including the support, the alignment film, and the diffraction element 10, an alignment film may be formed on the surface of the diffraction element 10, and the optically anisotropic layer 12 consisting of a liquid crystal compound may be formed on the alignment film.

The same applies to the adhesive layer 13 in the optical element according to the embodiment of the present invention.

That is, in the optical element shown in FIG. 1 described below, an alignment film may be formed on the surface of the optical refractive element 14, and the optically anisotropic layer 12 consisting of a liquid crystal compound may be formed on the alignment film.

The optical element according to the embodiment of the present invention includes the wavelength separation element according to the embodiment of the present invention, and the optical refractive element.

The optical element according to the embodiment of the present invention shown in FIG. 1 includes the wavelength separation element according to the embodiment of the present invention, including the diffraction element 10, the adhesive layer 11, and the optically anisotropic layer 12, and the optical refractive element 14. In the optical element, the optically anisotropic layer 12 and the optical refractive element 14 are bonded to each other by the adhesive layer 13.

### (Optical Refractive Element)

The optical refractive element 14 is used to control an incidence angle of incident light on the diffraction element 10 and to control a direction of the diffracted light.

The optical refractive element 14 is not limited, and various known members which can refract light can be used. Suitable examples of the optical refractive element 14 include a lens and a prism.

### (Film Thickness Distribution and Surface Roughness Ra of Entire Wavelength Separation Element)

In the wavelength separation element according to the embodiment of the present invention, the film thickness distribution of the entire wavelength separation element is within ±3.0% of an average film thickness, and the surface roughness (Ra) is 30 nm or less.

In the present invention, the entire wavelength separation element is a laminate of the diffraction element, the optically anisotropic layer, and an adhesive layer (or an alignment film layer) therebetween. That is, in the present invention, the entire wavelength separation element is from a surface of the diffraction element (surface opposite to the adhesive layer) to a surface of the optically anisotropic layer (surface opposite to the adhesive layer).

In the present invention, the surface roughness Ra is a surface roughness Ra of the diffraction element 10.

The wavelength separation element according to the embodiment of the present invention has such a configuration, and thus realizes a wavelength separation element which achieves a large diffraction angle by using the diffraction element satisfying the above expression (1) and suppresses the spread of diffracted light despite having such a large diffraction angle.

As is well known, the diffraction element basically has a larger diffraction angle as the wavelength of the light is longer, and thus acts as a wavelength separation element which separates the light according to the wavelength, in a case where light having a plurality of wavelengths is incident.

However, according to the studies of the present inventors, in a case where the diffraction element having a large diffraction angle, particularly the wavelength separation element is a laminate including the diffraction element, the diffracted light may spread, and in a severe case, light having the same wavelength may be separated.

The present inventors have intensively studied the cause. As a result, it has been found that the cause of the spread of the diffracted light is the film thickness distribution of the entire wavelength separation element and the surface roughness Ra of the wavelength separation element. That is, in a case where the film thickness distribution of the entire wavelength separation element and the surface roughness Ra of the wavelength separation element are large, the diffracted light spreads and is further separated.

Here, in the wavelength separation element, a large undulation such as the film thickness distribution may have a function (gentle refraction) similar to a lens having a large curvature radius. Therefore, in a case where the film thickness distribution of the wavelength separation element is large, this causes the diffracted light to spread.

In addition, in the wavelength separation element, the surface roughness Ra corresponding to the minute surface unevenness may have a function similar to the diffraction element itself. Therefore, in a case where the surface roughness Ra is large, this can cause the diffracted light having a single wavelength to be separated. In the following description, the “separation of the diffracted light” indicates the separation of the diffracted light having a single wavelength.

The present invention has been made by obtaining such findings, and the film thickness distribution of the entire wavelength separation element is within +3.0% of the average film thickness, and the surface roughness Ra is 30 nm or less. The wavelength separation element according to the embodiment of the present invention has such a configuration, and thus realizes a wavelength separation element which suppresses the spread of the diffracted light despite having a large diffraction angle.

In a case where the film thickness distribution of the entire wavelength separation element exceeds ±3.0% of the average film thickness, the spread of the diffracted light cannot be sufficiently suppressed, and the diffracted light is not correctly incident on a desired position of a light-receiving element such as LCOS and an optical fiber or only a part of the diffracted light is incident, which causes a problem.

In addition, in a case where the surface roughness Ra of the wavelength separation element exceeds 30 nm, the same problem as described above occurs, that is, the spread of the diffracted light cannot be sufficiently suppressed, and the diffracted light is not correctly incident on a desired position of a light-receiving element such as LCOS and an optical fiber or only a part of the diffracted light is incident, which causes a problem.

In the wavelength separation element according to the embodiment of the present invention, the film thickness distribution of the entire wavelength separation element is preferably within ±2.5% of the average film thickness, and more preferably within ±2.0% of the average film thickness.

In addition, in the wavelength separation element according to the embodiment of the present invention, the surface roughness Ra is preferably 25 nm or less, and more preferably 20 nm or less.

In the wavelength separation element according to the embodiment of the present invention, both the film thickness distribution of the entire wavelength separation element and the surface roughness Ra are preferably smaller, and there is no lower limit.

However, in consideration of productivity, production cost, yield, coating accuracy of the device, and the like, in the wavelength separation element according to the embodiment of the present invention, the film thickness distribution of the entire wavelength separation element is preferably the average film thickness ±0.5% or more. In addition, for the same reason, the surface roughness Ra of the wavelength separation element according to the embodiment of the present invention is preferably 1 nm or more.

In addition, in the wavelength separation element including the diffraction element, the optically anisotropic layer, and the adhesive layer (alignment film layer) therebetween, the spread and the separation of the diffracted light may occur in a case where a film thickness distribution and a surface roughness Ra of each member constituting the wavelength separation element are large, as described above.

In consideration of this point, in the wavelength separation element according to the embodiment of the present invention, the diffraction element, the adhesive layer (alignment film layer), and the optically anisotropic layer preferably have a small film thickness distribution and a small surface roughness Ra.

Specifically, in the wavelength separation element according to the embodiment of the present invention, it is preferable that the film thickness distribution of each of these members is within ±2.0% of the average film thickness, and the surface roughness Ra thereof is 20 nm or less.

The wavelength separation element according to the embodiment of the present invention is preferable in that the spread of the diffracted light can be more suitably suppressed, the separation of the diffracted light can be more suitably suppressed, and the diffracted light can be correctly incident on a desired position of a light-receiving element such as LCOS and an optical fiber by satisfying such conditions.

In the present invention, the film thickness distribution of each member constituting the wavelength separation element is more preferably within ±1.5% of the average film thickness, and still more preferably within ±1.0% of the average film thickness. In addition, in the present invention, the surface roughness Ra of each member constituting the wavelength separation element is more preferably 15 nm or less, and still more preferably 10 nm or less.

In the wavelength separation element including the diffraction element, the optically anisotropic layer, and the adhesive layer (alignment film layer) therebetween, a method of producing the wavelength separation element in which the film thickness distribution and the surface roughness Ra satisfy the above-described conditions is not limited, and various methods can be used.

As an example, a method of using a support having high surface smoothness and high rigidity (elastic modulus), such as a glass plate and a film with a hard coat layer, as the support for forming the diffraction element, particularly the liquid crystal diffraction element, and the optically anisotropic layer, particularly the optically anisotropic layer consisting of a liquid crystal compound is exemplified.

As will be described in Examples later, in the formation of the liquid crystal diffraction element and the optically anisotropic layer consisting of a liquid crystal compound, in a case where a general resin film such as a polyethylene terephthalate (PET) film is used as the support for forming at least one of the liquid crystal diffraction element or the optically anisotropic layer, the entire film thickness distribution and/or the surface roughness Ra tend to be large. On the other hand, by using the glass plate or the like as the support for forming the liquid crystal diffraction element and the optically anisotropic layer consisting of a liquid crystal compound, the wavelength separation element having the above-described film thickness distribution and the surface roughness Ra can be stably produced.

The order of the step of laminating each of the members is not particularly limited, and can be optionally selected.

Here, in a case where another layer is laminated on the layer having a large film thickness distribution and a large surface roughness, the film thickness distribution and the surface roughness may be further amplified. Accordingly, from the viewpoint of reducing the film thickness distribution of the entire wavelength separation element and the surface roughness Ra, it is preferable to laminate the layers from the layer having a small film thickness distribution and a small surface roughness Ra.

In addition, in addition to the film thickness distribution and the surface roughness Ra, the order of lamination can also be selected from the viewpoint of quality evaluation, manufacturing yield, cost reduction, and the like.

In addition, in a case where dust adheres to the surface of the member in a case of producing the diffraction element, the optically anisotropic layer, or the like, and in a case of bonding these members, the film thickness distribution of the entire wavelength separation element and the surface roughness Ra may be deteriorated even in a case where the member having high smoothness is used.

Therefore, in order to avoid the adhesion of the dust to these members, a clean room, an electrostatic removal fan, an air spray, and the like can be appropriately used in a case of producing each member, in a case of bonding the members, and the like.

The film thickness of the wavelength separation element can be measured, for example, by observing a cross section of the entire wavelength separation element and each of the constituent members using an optical microscope, a scanning electron microscope (SEM), or the like.

Specifically, the cross section of the entire wavelength separation element is imaged by SEM or the like at a plurality of cross sections (for example, five cross sections) at different positions to obtain image data, and the positions of the upper and lower end surfaces are extracted at a plurality of positions in each image data from the plurality of pieces of image data measured at different cross section positions, whereby the film thickness distribution and the average film thickness can be calculated.

In addition, the surface roughness Ra (arithmetic average roughness) can be measured, for example, using a commercially available measuring device such as a non-contact surface/layer cross-sectional shape measurement system VertScan (manufactured by Ryoka Systems Inc.).

### EXAMPLES

Hereinafter, the characteristics of the present invention will be described in detail by Examples.

Materials, chemicals, used amounts, material amounts, ratios, treatment details, treatment procedures, and the like shown in the following examples can be appropriately changed within a range not departing from the scope of the present invention. Accordingly, the scope of the present invention should not be construed as being limited by the specific examples given below.

### (Formation of Liquid Crystal Diffraction Element)

The following composition 1 was prepared as a liquid crystal composition for forming a liquid crystal diffraction element.

### Composition 1

| | | |
|---|---|---|
| Rod-like liquid crystal compound L-1 | 100.00 | parts by mass |
| Photopolymerization initiator (manufactured by | 1.00 | part by mass |
| Nippon Kayaku Co., Ltd., KAYACURE | | |
| DETX-S) | | |
| Chiral agent Ch-1 | 1.70 | parts by mass |
| Methyl ethyl ketone | 142.06 | parts by mass |

Rod-like liquid crystal compound L-1 (including the following structures at a mass ratio shown on the right side)

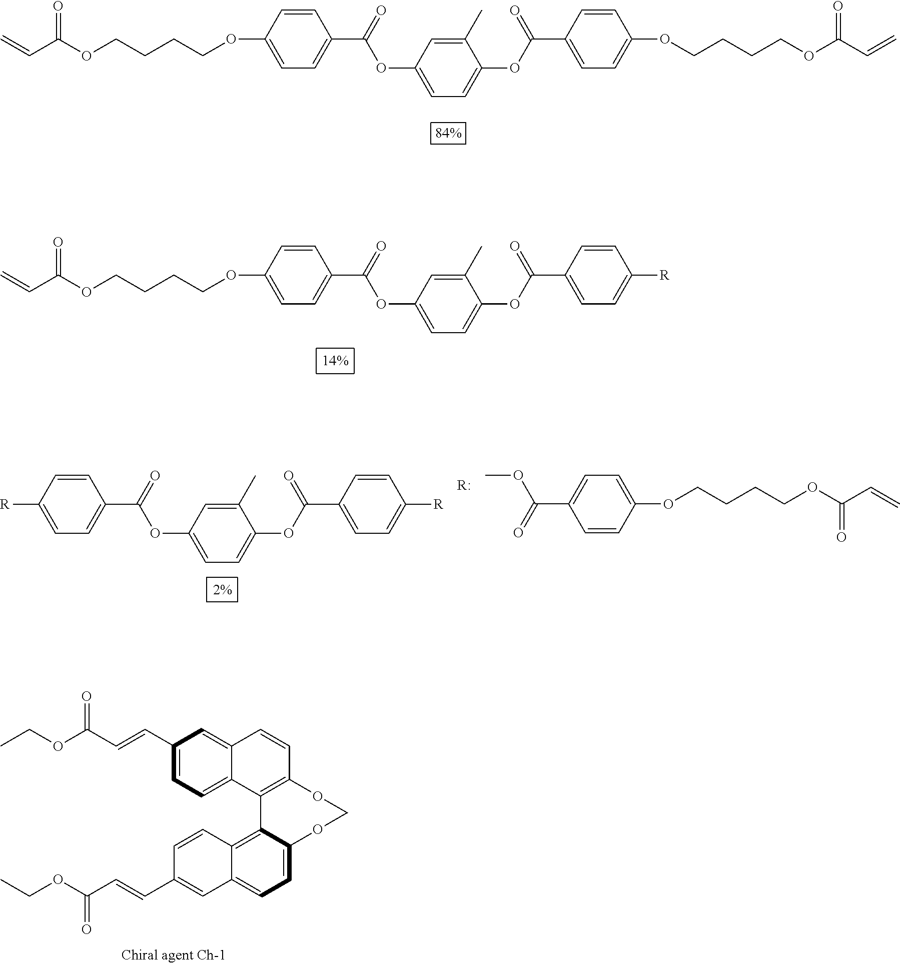

Next, a composition containing a photo-alignment material (manufactured by DIC Corporation, SD-1) was applied onto a support (manufactured by Corning Incorporated, EagleXG) made of glass, and dried. The coating film was subjected to interference exposure using an exposure device shown in FIG. 3 of WO2021/256413A to form a photo-alignment film. Thereafter, the above-described composition 1 was applied onto the photo-alignment film, dried, and UV-cured in a nitrogen atmosphere to form a reflective type liquid crystal diffraction element.

### (Formation of Optically Anisotropic Layer (Example 1))

The following composition 2 was prepared as a liquid crystal composition for forming an optically anisotropic layer.

### Composition 2

| | | |
|---|---|---|
| Rod-like liquid crystal compound L-1 | 100.00 | parts by mass |
| Photopolymerization initiator (manufactured by | 1.00 | part by mass |
| Nippon Kayaku Co., Ltd., KAYACURE | | |
| DETX-S) | | |
| Surfactant-1 | 0.20 | parts by mass |
| Methyl ethyl ketone | 142.06 | parts by mass |

### Surfactant-1

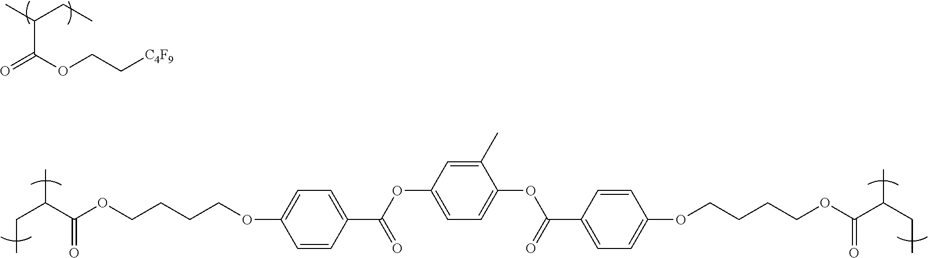

Next, a composition containing a photo-alignment material was applied onto a support (manufactured by Corning Incorporated, EagleXG; elastic modulus: 77 GPa) made of glass, and dried. The coating film was exposed to polarized UV light to form a photo-alignment film.

The above-described composition 2 was applied onto the formed photo-alignment film and dried. Thereafter, the composition 2 was UV-cured in a nitrogen atmosphere to form an optically anisotropic layer.

### Comparative Example 1

An optically anisotropic layer was formed in the same manner as in Example 1, except that a PET film (manufactured by FUJIFILM Corporation, film thickness: 50 μm) was used as the support for forming the optically anisotropic layer, instead of the glass plate.

### Comparative Example 2

An optically anisotropic layer was formed in the same manner as in Example 1, except that the optically anisotropic layer (composition 2) was dried while blowing strong wind.

### Comparative Example 3

An optically anisotropic layer was formed in the same manner as in Example 1, except that a PET film (manufactured by FUJIFILM Corporation, film thickness: 50 μm) was used as the support for forming the optically anisotropic layer, instead of the glass plate, and the optically anisotropic layer (composition 2) was dried while blowing strong wind.

### (Production of Wavelength Separation Element)

The liquid crystal diffraction element and each optically anisotropic layer formed as described above were bonded to each other through a UV adhesive (manufactured by NORLAND PRODUCTS INCORPORATED, NOA87).

After UV-curing the UV adhesive, each support was peeled off to form a wavelength separation element.

### (Production of Wavelength Separation Element of Example 1)

A UV adhesive (manufactured by NORLAND PRODUCTS INCORPORATED, NOA87) was applied onto a liquid crystal diffraction element layer formed using a glass support. Thereafter, the optically anisotropic layer formed using the glass support was pressed against the optically anisotropic layer side to be the UV adhesive side, and irradiated with UV light to bond the layers.

Thereafter, the photo-alignment film was dissolved with pure water to peel off the bonding layer of the liquid crystal diffraction element and the optically anisotropic layer from the support, thereby producing a wavelength separation element of Example 1.

Accordingly, the wavelength separation element had a configuration in which the liquid crystal diffraction element, the adhesive layer, and the optically anisotropic layer were laminated in this order.

### (Production of Wavelength Separation Element of Comparative Example 1)

A wavelength separation element of Comparative Example 1 was produced in the same manner as in Example 1, except that the optically anisotropic layer formed using a support made of PET film was used.

### (Production of Wavelength Separation Element of Comparative Example 2)

A wavelength separation element of Comparative Example 2 was produced in the same manner as in Example 1, except that the optically anisotropic layer formed by drying while blowing strong wind using a glass support was used.

### (Production of Wavelength Separation Element of Comparative Example 3)

A wavelength separation element of Comparative Example 3 was produced in the same manner as in Example 1, except that the optically anisotropic layer formed by drying while blowing strong wind using a support made of PET film was used.

### (Evaluation of Film Thickness Distribution and Surface Roughness Ra)

The surface roughness Ra and the film thickness distribution of the produced wavelength separation element were measured.

The surface roughness Ra was measured using VertScan (manufactured by Ryoka Systems Inc.). The surface roughness Ra was measured on the surface of the diffraction element.

In addition, the film thickness distribution was calculated from five SEM images obtained by cutting a part of the produced wavelength separation element and imaging a cross section with SEM. The positions of the upper and lower interfaces of the SEM image were profiled by image processing, a film thickness at each position was calculated from the position information (100 data/piece) and the magnification, and the average of these values was defined as an average value (average film thickness) of the film thickness.

In addition, the film thickness distribution was calculated from the following expression.

$$Film thickness distribution on + side : 100 \times ( Maxium value of film thickness - Average value of film thickness ) / ( Average value of film thickness )$$

$$Film thickness distribution on - side : 100 \times ( Maxium value of film thickness - Average value of film thickness ) / ( Average value of film thickness )$$

### (Evaluation of Spread of Diffracted Light)

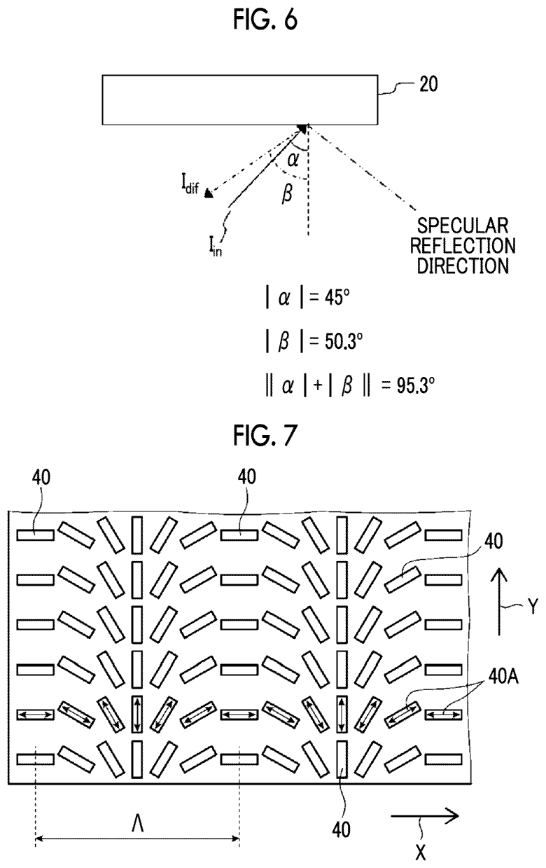

As conceptually shown in FIG. 6, an infrared laser (manufactured by Craft Center SAWAKI Inc., FOLS-02, 1550 nm laser, laser diameter: 10 mm) was incident from the surface of the produced wavelength separation element on a diffraction element 20 side, and the beam diameter of the diffracted light was measured as the spread of the diffracted light using a beam profiler (manufactured by Thorlabs, Inc., BP209IR1/M). In FIG. 6, only the diffraction element 20 is shown for simplification of the drawing.

An incidence angle of incident light Iᵢₙ (infrared laser (solid line)) was set to 45°. That is, the absolute value (|α|) of the angle α between the normal line (broken line) of the diffraction element 20 and the specular reflection direction (two-dot chain line) of the incident light Iᵢₙ was set to 45°.

In addition, in the present example, in all the diffraction elements 20 of the wavelength separation elements, the absolute value (|β|) of the diffraction angle β of the diffracted light I_{dif} (one-dot chain line) was set to 50.3°.

Furthermore, in the present example, in all the diffraction elements 20 of the wavelength separation elements, the direction of the diffracted light I_{dif} was different from the direction toward the specular reflection direction with respect to the normal line of the diffraction element plane.

Accordingly, in the present example, ∥α|+|β∥=|45°+50.3°|=95.3°.

The results of the film thickness distribution, the surface roughness, and the corresponding spread of the diffracted light are shown in Table 1. It was found that, in Example 1, the laser diameter did not change, whereas in Comparative Examples, the laser diameter was widened.

From this, the effects of the present application are clear.

TABLE 1

| | | Surface | | |
|---|---|---|---|---|
| | Film thickness | roughness | Spread of | |
| | distribution | Ra | diffracted light | \|\|α\| + \|β\|\| |
| Example 1 | +1.0%, −0.8% | 10 nm | 10 mm | 95.3° |
| Comparative | +5.0%, −5.3% | 10 nm | 21 mm | 95.3° |
| Example 1 | | | | |
| Comparative | +1.1%, −0.9% | 50 nm | 14 mm | 95.3° |
| Example 2 | | | | |
| Comparative | +4.9%, −5.5% | 50 nm | 29 mm | 95.3° |
| Example 3 | | | | |

### EXPLANATION OF REFERENCES

10, 20: diffraction element
11: adhesive layer
12: optically anisotropic layer
13: adhesive layer
14: optical refractive element

What is claimed is:

1. A wavelength separation element comprising at least:
a diffraction element;
an optically anisotropic layer; and
an adhesive layer or an alignment film layer between the diffraction element and the optically anisotropic layer,
wherein the diffraction element is a diffraction element in which an absolute value (|α|) of an angle α between a normal line of a diffraction element plane and a specular reflection direction or a specular transmission direction of incident light and an absolute value (|β|) of a diffraction angle β of the diffraction element satisfy an expression (1), and
a film thickness distribution of an entire wavelength separation element is within ±3.0% of an average film thickness and a surface roughness (Ra) is 30 nm or less,
∥α|±|β∥≥20° the expression (1),
here, in a case where a direction of the diffracted light is different from a direction from the normal line of the diffraction element plane toward the specular reflection direction or the specular transmission direction, the sign is positive (+), and in a case where the direction of the diffracted light is the same as the direction from the normal line of the diffraction element plane toward the specular reflection direction or the specular transmission direction, the sign is negative (−).

2. The wavelength separation element according to claim 1,
wherein the diffraction element is a liquid crystal diffraction element.

3. The wavelength separation element according to claim 1,
wherein the diffraction element is a laminate of a plurality of liquid crystal diffraction elements.

4. The wavelength separation element according to claim 2,
wherein the optically anisotropic layer consists of a liquid crystal compound.

5. The wavelength separation element according to claim 1,
wherein the optically anisotropic layer consists of a liquid crystal compound and is a λ/4 plate.

6. An optical element comprising:
the wavelength separation element according to claim 1; and
an optical refractive element.

7. The wavelength separation element according to claim 2,
wherein the diffraction element is a laminate of a plurality of liquid crystal diffraction elements.

8. The wavelength separation element according to claim 1,
wherein the optically anisotropic layer consists of a liquid crystal compound.

9. The wavelength separation element according to claim 2,
wherein the optically anisotropic layer consists of a liquid crystal compound and is a λ/4 plate.

10. An optical element comprising:
the wavelength separation element according to claim 2; and
an optical refractive element.

11. The wavelength separation element according to claim 3,
wherein the optically anisotropic layer consists of a liquid crystal compound.

12. The wavelength separation element according to claim 3,
wherein the optically anisotropic layer consists of a liquid crystal compound and is a λ/4 plate.

13. An optical element comprising:
the wavelength separation element according to claim 3; and
an optical refractive element.

14. The wavelength separation element according to claim 4,
wherein the optically anisotropic layer consists of a liquid crystal compound and is λ/4 plate.

15. An optical element comprising:
the wavelength separation element according to claim 4; and
an optical refractive element.

16. An optical element comprising:
the wavelength separation element according to claim 5; and
an optical refractive element.
